(19) United States
(12) Patent Application Publication
(10) Pub. No.: US 2012/0229748 A1
(43) Pub. Date: Sep. 13, 2012

(54) Liquid Crystal Display Device and Manufacturing Method Thereof

(76) Inventors: Masaharu Itakura, Shirako (JP); Kazuo Saito, Togane (JP)

(21) Appl. No.: 13/408,079

(22) Filed: Feb. 29, 2012

(30) Foreign Application Priority Data
Mar. 8, 2011 (JP) 2011-050290

(51) Int. Cl. G02F 1/1333; B29C 45/14; G02F 1/1339

(52) U.S. Cl. 349/138; 349/154; 264/478

(57) ABSTRACT

There is provided a liquid crystal display device and a manufacturing method of the liquid crystal display device including a liquid crystal display panel. The liquid crystal display panel includes a pair of substrates, a sealing material provided in the periphery of the pair of substrates, and a liquid crystal injected between the pair of substrates and the sealing material. A liquid crystal injection port is formed in a portion of the sealing material. A sealant is provided to seal the liquid crystal injection port. The portion of the sealant entering the liquid crystal display panel, which faces the sealing material, is fully bonded to the sealing material to prevent degradation of the adhesive strength of the sealant of the liquid crystal display panel.

### CLAIM OF PRIORITY

The present application claims priority from Japanese Patent Application JP 2011-050290 filed on Mar. 8, 2011, the content of which is hereby incorporated by reference into this Application.

### BACKGROUND OF THE INVENTION

1. Field of the Invention

The present invention relates to a liquid crystal display device and a manufacturing method thereof, and more particularly, to a technique effective for sealing a liquid crystal injection port of a liquid crystal display panel by a sealant of a resin.

2. Description of the Related Art

A liquid crystal display panel of a liquid crystal display device has a pair of substrates including a first substrate and a second substrate, a sealing material provided in the periphery of the first and second substrates, and a liquid crystal injected between the first and second substrates and the sealing material (JP-A No. 2008-304496).

Then, a liquid crystal injection port is formed in a portion of the sealing material. The liquid crystal injection port is sealed by curing a sealant of a UV curable resin by irradiation with ultraviolet light.

### SUMMARY OF THE INVENTION

As described above, a liquid crystal injection port of a liquid crystal display panel is sealed by a sealant of a UV curable resin. At this time, the UV curable resin enters the liquid crystal display panel.

Then, the sealant of the UV curable resin is cured by irradiation with ultraviolet light. The curing speed of the portion of the UV curable resin entering the liquid crystal display panel is slow compared to the other part of the UV curable resin. For this reason, the liquid crystal flows back into the area where the UV curable resin enters the liquid crystal display panel before the UV curable resin is cured. In this case, the UV curable resin does not necessarily come into full contact with the sealing material in the area where the UV curable resin enters the liquid crystal display panel. Thus, there is a problem that the adhesion strength of the sealant is degraded.

The present invention is to solve the above problems of the related art, and to provide a technique for preventing the adhesive strength of the sealant from being degraded due to imperfect contact with the sealing material in the area where the sealant enters the liquid crystal display panel in the liquid display device.

Other objects, advantages and novel features of the present invention will be apparent from the following detailed description when read in conjunction with the appended claims and the drawings attached hereto.

A summary of representative aspects of the invention disclosed in the present application will be described in brief as follows.

(1) There is provided a liquid crystal display device including a liquid crystal display panel. The liquid crystal display panel includes a pair of substrates, a sealing material provided in the periphery of the pair of substrates, and a liquid crystal injected between the pair of substrates and the sealing material. A liquid crystal injection port is formed in a portion of the sealing material. A connecting portion connecting a straight body of the sealing material and the liquid crystal injection port is folded on the outside of the liquid crystal display panel. The distance of the connecting portion of the sealing material increases toward the inside of the liquid crystal display panel. A sealant is provided to seal the liquid crystal injection port. The sealant enters the liquid crystal display panel. Then, a portion of the sealant entering the liquid crystal display panel, which faces the connecting portion of the sealing material, is fully bonded to the connecting portion of the sealing material
(2) In the liquid crystal display device described in (1), an insulating film is formed on one of the pair of substrates. The insulating film is formed at a predetermined distance from an area where the liquid crystal injection port is formed. Further, a step is formed between an end portion on the side of the liquid crystal injection port of the insulting film and the particular substrate on which the insulating film is formed.
(3) In the liquid crystal display device described in (2), when the film thickness of the insulating film is d1 and the thickness of the liquid crystal is d2, the relationship between d1 and d2 satisfies the following conditions: ⅔≦d1/d2≦½.
(4) In the liquid crystal display device described in (1), the width of the liquid crystal injection port is greater in the center than on the side of the pair of substrates.
(5) There is provided a method of manufacturing a liquid crystal display device including a liquid crystal display panel. The liquid crystal display panel includes a pair of substrates, a sealing material provided in the periphery of the pair of substrates, and a liquid crystal injected between the pair of substrates and the sealing material. A liquid crystal injection port is formed in a portion of the sealing material. A connecting portion connecting a straight body of the sealing material and the liquid crystal injection port is folded on the outside the liquid crystal display panel. The distance of the connecting portion of the sealing material increases toward the inside of the liquid crystal display panel. A sealant is provided to seal the liquid crystal injection port. At this time, the sealant enters the liquid crystal display panel. The method includes the following steps: forming the sealing material around the pair of substrates with the liquid crystal injection port formed in a portion thereof; injecting liquid crystal between the pair of substrates and the sealing material; applying a UV curable resin to the liquid crystal injection port so that the UV curable resin enters the liquid crystal display panel; and sealing the liquid crystal injection port by curing the UV curable resin by a light source capable of irradiating light from at least either an upward or downward direction with respect to the liquid crystal display panel.
(6) In the manufacturing method of the liquid crystal display device described in (5), an insulating film is formed on one of the pair of substrates. The insulating film is formed at a predetermined distance from an area where the liquid crystal injection port is formed. Further, a step is formed between an end portion on the side of the liquid crystal injection port of the insulating film and the particular substrate on which the insulating film is formed. In the process of sealing the liquid crystal injection port, light is emitted from at least one side of the pair of substrates.
(7) In the manufacturing method of the liquid crystal display device described in (6), the light source is a fiber light source. In the process of sealing the liquid crystal injection port, the light is emitted from at least one side of the pair of substrates by means of the fiber light source.

Advantageous effects obtained by a typical one of the inventions disclosed in the present application will be described in brief as follows.

According to the present invention, the liquid crystal display device can prevent the adhesive strength of the sealant from being degraded due to imperfect contact with the sealing material in the area where the sealant enters the liquid crystal display panel.

### BRIEF DESCRIPTION OF THE DRAWINGS

FIG. 1 is a cross-sectional view of a substantial part, which is an example of a schematic cross-sectional structure of a liquid crystal display panel according to the present invention;

FIGS. 2A and 2B are views of the liquid crystal display panel, mainly showing a sealing material, a liquid crystal injection port, and a sealant according to an embodiment of the present invention;

FIG. 3 is a cross-sectional view taken along line A-A′ of FIG. 2A, showing the cross-sectional structure in the vicinity of the sealing material;

FIGS. 4A and 4B are views showing a sealing method in an existing liquid crystal display panel;

FIG. 5 is a view showing a UV light irradiation method in the sealing process of the existing liquid crystal display panel;

FIG. 6 is a view of an example of the liquid crystal injection port of the existing liquid crystal display panel;

FIG. 7 is a cross-sectional view that shows a cross-sectional structure taken along line B-B′ of FIG. 6;

FIG. 8 is a view of another example of the liquid crystal injection port of the existing liquid crystal display panel;

FIG. 9 is a view showing a UV irradiation method in the sealing process of the liquid crystal display panel according to an embodiment of the present invention;

FIG. 10 is a view showing the liquid crystal injection port of the liquid crystal display panel according to an embodiment of the present invention; and

FIG. 11 is a view of another example of the UV irradiation method in the sealing process of the liquid crystal display panel according to an embodiment of the present invention.

### DETAILED DESCRIPTION OF THE INVENTION

Hereinafter, an embodiment of the present invention will be described in detail with reference to the accompanying drawings.

Note that components having the same function are denoted by the same reference symbols throughout the drawings for describing the embodiment, and a repetitive description thereof is omitted. Further, the following embodiment is not intended to limit interpretation of the scope of the claims.

### [Example of the Structure of a Liquid Crystal Display Panel According to the Present Invention]

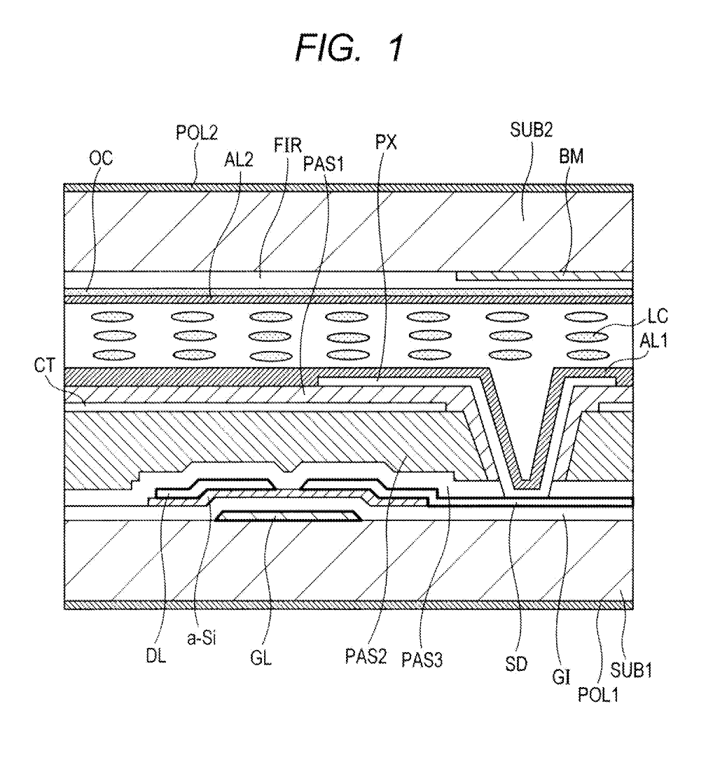

FIG. 1 is a cross-sectional view of a substantial portion, showing an example of the schematic cross-sectional structure of a liquid crystal display panel according to the present invention.

In the present invention, it is assumed that a liquid crystal display panel includes a first substrate (SUB1), which is also referred to as a TFT substrate, and a second substrate (SUB2), which is also referred to as a CF substrate. The first substrate (SUB1) and the second substrate (SUB2) are provided with a liquid crystal layer (LC) interposed therebetween. In the liquid crystal display panel shown in FIG. 1, the main front surface side of the second substrate (SUB2) is the observation side.

As shown in FIG. 1, on the side of the liquid crystal layer of the first substrate (SUB1), a scan line (also referred to as a gate line) (GL), a gate insulating film (GI), a semiconductor layer (a-Si), an image line (also referred to as a drain line) (DL), a conductive layer (SD) that functions as a source electrode, an interlayer insulating film (PAST3), an interlayer insulating film (PAS2), a counter electrode (CT) that is also referred to as a common electrode, an interlayer insulating film (PAS1), a pixel electrode (PX), and a first orientation film (AL1) are formed in this order from the first substrate (SUB1) to the liquid crystal layer (LC). Note that a first polarizing film (POL1) is provided on the outside of the first substrate (SUB1).

Further, a thin film transistor (TFT) includes a portion (gate electrode) of the scan line (GL), the gate insulating film (GI), the semiconductor layer (a-Si), a portion (drain electrode) of the image signal line (DL), and the conductive layer (source electrode (SD)).

On the side of the liquid crystal layer of the second substrate (SUB2), a black matrix (light shielding film: BM), a color filter (FIR) of red, green, and blue, a flattening film (OC), and a second orientation film (AL2) are formed in this order from the second substrate (SUB2) to the liquid crystal layer (LC). Then, a second polarizing film (POL2) is provided on the outside of the second substrate (SUB2).

Note that in the liquid crystal display panel shown in FIG. 1, the counter electrode (CT) is formed in a planar shape, and the pixel electrode (PX) has a plurality of slits.

### Embodiment

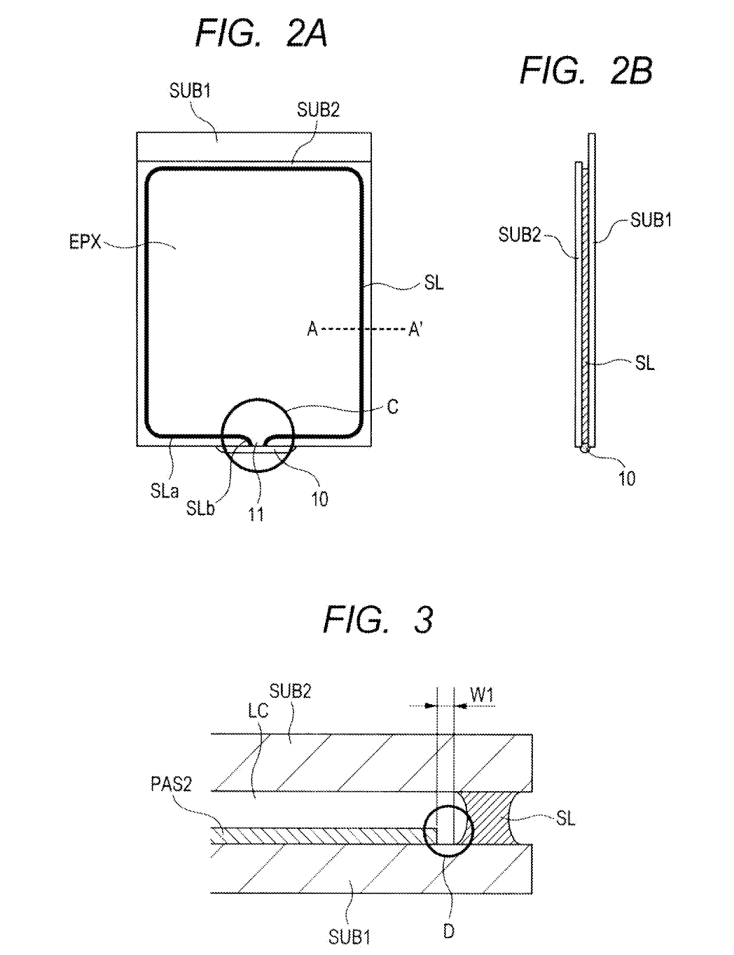

FIGS. 2A and 2B are views of the liquid crystal display device according to an embodiment of the present invention, particularly showing the sealing material (SL), a liquid crystal injection port 11, and a sealant 10. FIG. 2A is a front view and FIG. 2B is a side view.

As shown in FIG. 2A, the sealing material (SL) is formed in the periphery of the first substrate (SUB1) and the second substrate (SUB2) to bond the first substrate (SUB1) and the second substrate (SUB2) together. The liquid crystal injection port 11 is formed in a portion of the sealing material (SL), namely, a portion of the short side where the first substrate (SUB1) and the second substrate (SUB2) overlap. The liquid crystal injection port 11 is sealed by the sealant 10.

The liquid crystal injection port 11 is formed on one of the two short sides of the first substrate (SUB1) and the second substrate (SUB2). The sealing material (SL) includes the straight body (SLa) and a connecting portion (SLb) connecting the straight body (SLa) and the liquid crystal injection port 11. Then, the connecting portion (SLb) of the sealing material (SL) is folded on the outside of the liquid crystal display panel. The distance of the connecting portion (SLb) of the sealing material (SL) increases toward the inside of the liquid crystal display panel.

Here, for example, the first substrate (SUB1) and the second substrate (SUB2) are formed by transparent substrates such as glass substrates and plastic substrates. The sealing material (SL) is formed by an epoxy resin and the like. Further, the sealant 10 is formed of a UV curable resin. Note that in FIG. 2A, EPX represents the area where pixels are formed.

FIG. 3 is a cross-sectional view taken along line A-A′ of FIG. 2A, which shows a cross-sectional structure in the vicinity of the sealing material (SL).

As shown in FIG. 3, the width of the sealing material (SL) is smallest in the middle in the thickness direction of the liquid crystal layer (LC). Further, the interlayer insulating film (PAS2) is extended close to the sealing material (SL). In FIG. 3, the width (W1 in FIG. 3) between the end portion of the interlayer insulating film (PAS2) and the sealing material (SL) is about 0.5 mm. Further, the film thickness of the interlayer insulating film (PAS2) is about 2 μm, and the thickness of the liquid crystal layer (LC) is about 3 to 4 μm. Thus, when the film thickness of the interlayer insulating film (PAS2) is d1 and the thickness of the liquid crystal layer (LC) is d2, ⅔≦d1/d2≦½ is obtained.

First, the sealing method in the liquid crystal display panel will be described.

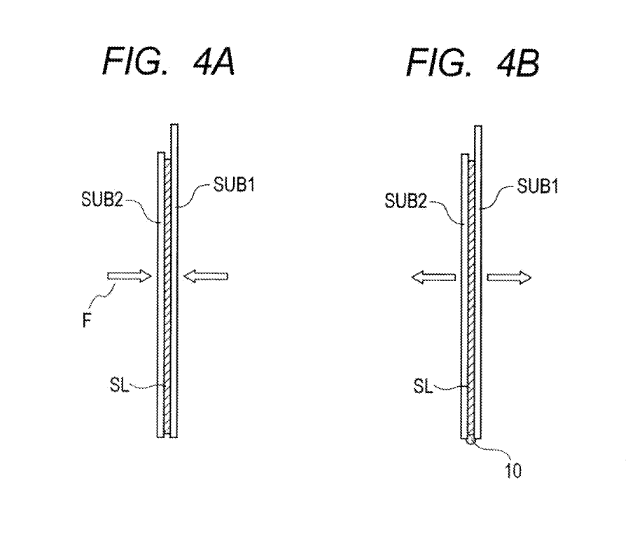

Liquid crystal is injected from the liquid crystal injection port 11 into the portion surrounded by the sealing material (SL) between the first substrate (SUB1) and the second substrate (SUB2). Then, as shown in FIG. 4A, a force F is applied to the liquid crystal display panel. In the state in which pressure is applied to the liquid crystal display panel, the UV curable resin constituting the sealant 10 is applied to the liquid crystal injection port 11. Then, as shown in FIG. 4B, the pressure of the liquid crystal display panel is reduced. Thus, a portion of the UV curable resin constituting the sealant 10 is drawn into the liquid crystal display panel. In other words, the portion of the curable resin enters the liquid crystal display panel.

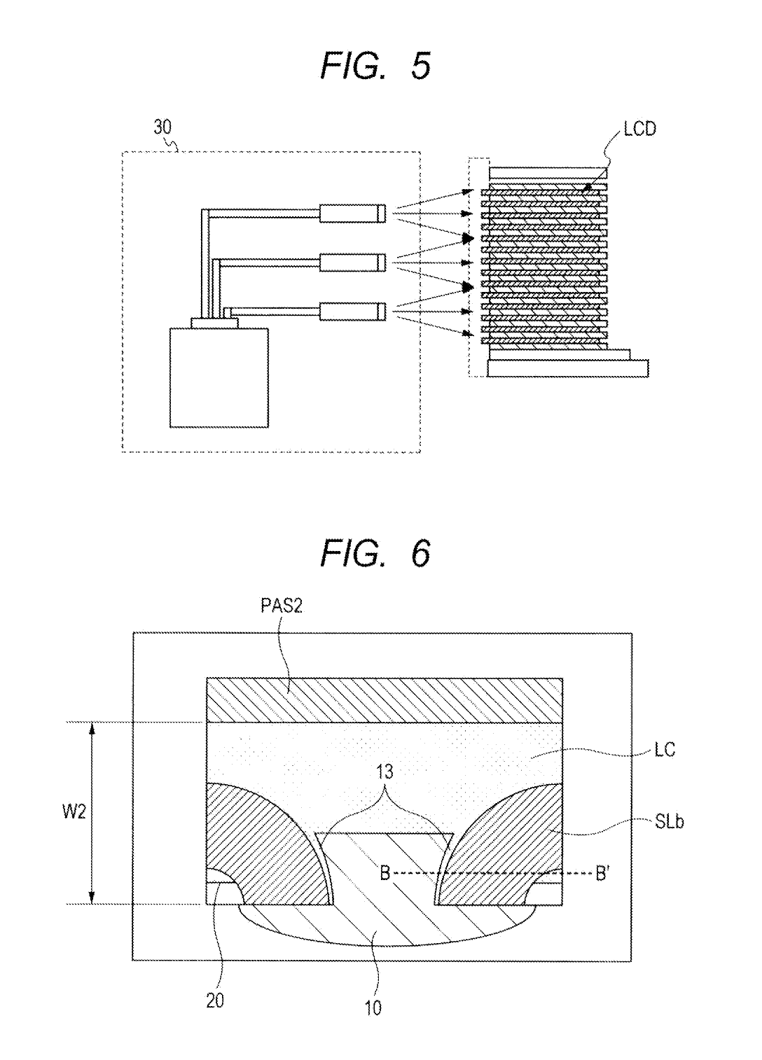

Next, as shown in FIG. 5, a plurality of liquid crystal display panels (LCD) are stacked. Then, the UV curable resin constituting the sealant 10 is cured by means of a fiber light source to seal the liquid crystal injection port 11.

However, the area where the-UV curable resin enters the liquid crystal display panel (LCD) is only indirectly irradiated with ultraviolet light from the side to which the sealant 10 is applied. Thus, the curing speed is slower in the portion of the UV curable resin entering the liquid crystal display panel (LCD), than in the other portion of the UV curable resin. As a result, the liquid crystal flows back, and a leakage portion (non-bonded portion) is generated on the sealant 10.

This point will be described in detail below.

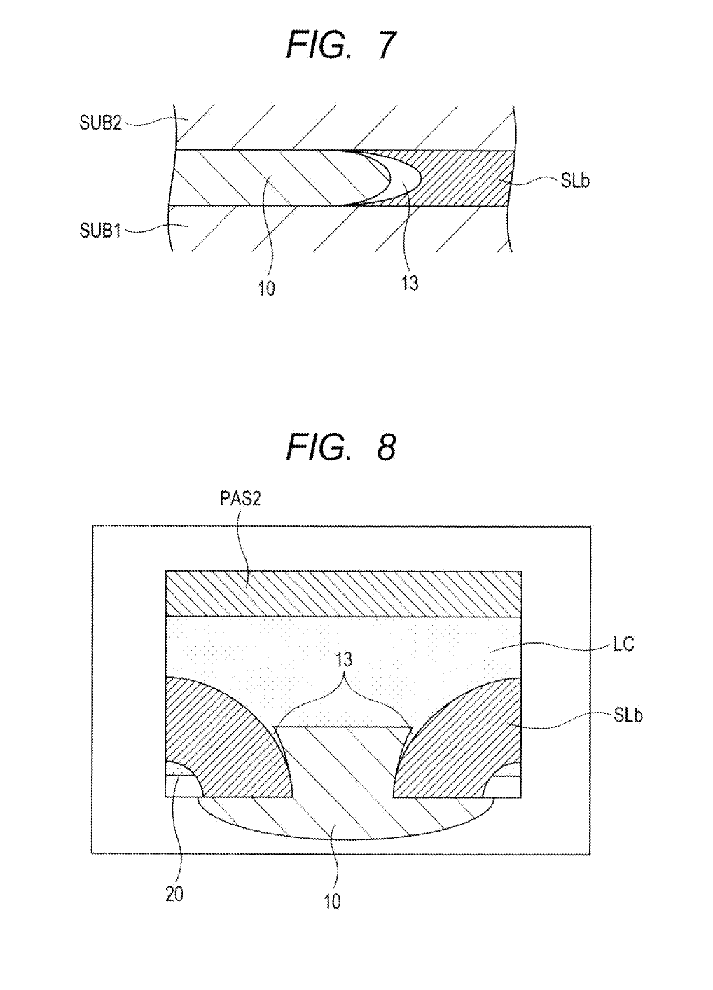

FIG. 6 is a view showing a liquid crystal injection port of an existing liquid crystal display panel, which is an enlarged view of the portion (C) surrounded by a circle shown in FIG. 2A. FIG. 7 is a cross-sectional view that shows the cross-sectional structure taken along line B-B′ of FIG. 6.

In FIG. 6, reference numeral 13 denotes the leakage portion described above. In other words, the leakage portion 13 is formed such that the liquid crystal (LC) flows back between the portion of the sealant 10 entering the liquid crystal display panel and the connecting portion (SLb) of the sealing material (SL). As a result, the portion of the sealant 10 entering the liquid crystal display panel and the connecting portion (SLb) of the sealing material (SL) are not bonded together.

Note that as shown in FIG. 7, the width of the leakage portion 13 is largest in the middle in the thickness direction of the liquid crystal layer (LC).

As described above, in the existing liquid crystal display panel, the formation of the leakage portion 13 reduces the adhesive strength of the sealant 10. In the drop test or other tests in the assembly and testing process, there is a problem that the sealant 10 is removed from the liquid crystal display panel.

Note that in FIG. 6, it is assumed that the leakage portion 13 is formed so that the end of the leakage portion 13 reaches the end of the liquid crystal injection port 11 (namely, the end portion of the first substrate (SUB1) and the second substrate (SUB2)). In the actual product, however, even if the end of the leakage portion 13 does not reach the end of the liquid crystal injection port 11 as shown in FIG. 8, the leakage portion 13 is necessarily formed.

Here, the reason why the liquid crystal flows back may be that, as shown in FIG. 4B, the liquid crystal is drawn into the liquid crystal display panel also at the time when the pressure of the liquid crystal display panel is reduced, but the pressure reduction state of the liquid crystal display panel is resolved at the time of irradiation with ultraviolet light.

As shown in FIG. 3, the greater the step difference between the interlayer insulating film (PAS2) and the first substrate (SUB1) shown in the portion (D), the more the back-flow is likely to occur.

In FIG. 6, reference numeral 20 denotes a boundary of the black matrix (light shielding film: BM) on the second substrate (SUB2). The black matrix (light shielding film: BM) is formed on the second substrate (SUB2) in the area inside the line 20 shown in FIG. 6.

Further, as shown in FIG. 6, there is a distance of about 1 mm (W2 in FIG. 6) between the end of the interlayer insulating film (PAS2) and the end of the liquid crystal injection port 11 (the end portion of the first substrate (SUB1) and the second substrate (SUB2)). When the second substrate (SUB2) is a transparent substrate such as a glass substrate, the portion of the distance between the end of the interlayer insulating film (PAS2) and the end of the liquid crystal injection port 11 is transparent, which will be referred to as the transparent area.

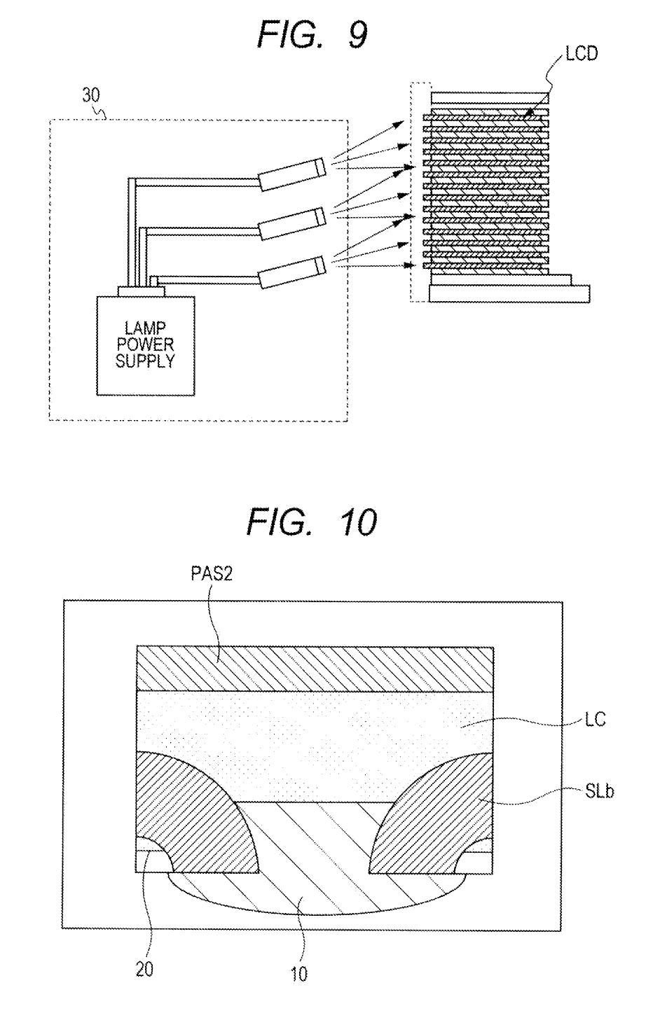

In this embodiment, as shown in FIG. 9, in the curing process of the UV curable resin constituting the sealant 10, ultraviolet light is irradiated from the lower side of the liquid crystal display panel (LCD) in an oblique direction. Then, the UV curable resin constituting the sealant 10 is irradiated with ultraviolet light through the transparent area described above.

Thus, in this embodiment, the area where the UV curable resin enters the liquid crystal display panel is irradiated with ultraviolet light not only indirectly from the side to which the sealant 10 is applied but also from the underside of the liquid crystal display panel. This can increase the curing speed of the portion of the UV curable resin entering the liquid crystal display panel.

As a result, as shown in FIG. 10, it is possible to prevent the formation of the leakage portion in the area where the sealant 10 enters the liquid crystal display panel.

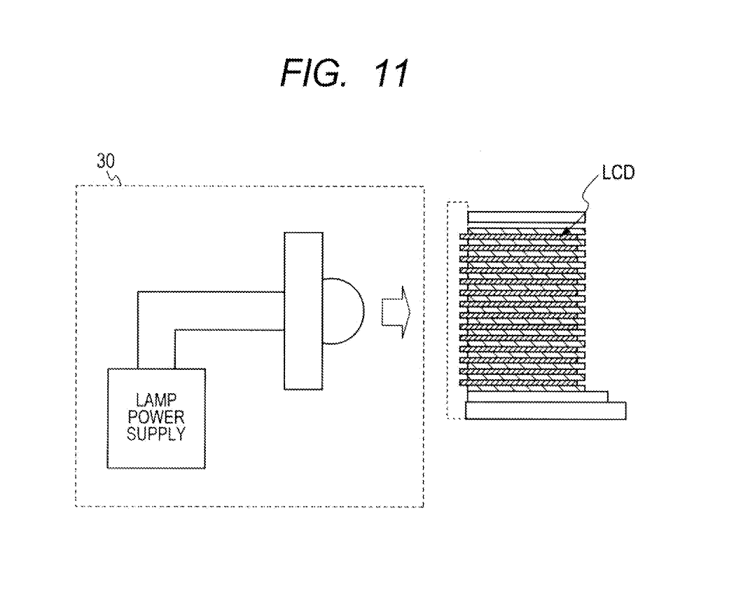

Note that in this embodiment, as shown in FIG. 11, it is also possible to cure the UV curable resin constituting the sealant 10 by means of a lamp light source 31 by irradiating from at least one direction of upward and downward.

In this case also, the area where the UV curable resin enters the liquid crystal display panel is irradiated with ultraviolet light not only indirectly from the side to which the sealant 10 is applied but also from the top or bottom of the liquid crystal display panel. This can increase the curing speed of the portion of the UV curable resin entering the liquid crystal display panel.

As a result, as shown in FIG. 10, it is possible to prevent the formation of the leakage portion in the area where the sealant 10 enters the liquid crystal display panel.

The invention accomplished by the inventors has been specifically described with reference to the embodiment thereof. It is to be noted, however, that the invention is not limited to the above embodiment and various modifications and changes may be made thereto within the scope of the invention.

What is claimed is:

1. A liquid crystal display device comprising a liquid crystal display panel,
wherein the liquid crystal display panel includes:
a pair of substrates;
a sealing material provided in the periphery of the pair of substrates; and
a liquid crystal injected between the pair of substrates and the sealing material,
wherein a liquid crystal injection port is formed in a portion of the sealing material,
wherein a connecting portion connecting a straight body of the sealing material and the liquid crystal injection port is folded on the outside of the liquid crystal display panel,
wherein the distance of the connecting portion of the sealing material increases toward the inside of the liquid crystal display panel,
wherein a sealant is provided to seal the liquid crystal injection port,
wherein the sealant enters the liquid crystal display panel, and
wherein a portion of the sealant entering the liquid crystal display panel, which faces the connecting portion of the sealing material, is fully bonded to the connecting portion of the sealing material.

2. The liquid crystal display device according to claim 1,
wherein an insulating film is formed on one of the pair of substrates,
wherein the insulating film is formed at a predetermined distance from an area where the liquid crystal injection port is formed, and
wherein a step is formed between an end portion on the side of the liquid crystal injection port of the insulating film and the particular substrate on which the insulating film is formed.

3. The liquid crystal display device according to claim 1,
wherein when the film thickness of the insulating film is d1 and the thickness of the liquid crystal is d2, the relationship between d1 and d2 satisfies the following conditions: ⅔≦d1/d2≦½.

4. The liquid crystal display device according to claim 1,
wherein the width of the liquid crystal injection port is greater in the center than on the side of the pair of substrates.

5. A manufacturing method of a liquid crystal display device comprising a liquid crystal display panel,
wherein the liquid crystal display panel includes:
a pair of substrates;
a sealing material provided in the periphery of the pair of substrates; and
a liquid crystal injected between the pair of substrates and the sealing material,
wherein a liquid crystal injection port is formed in a portion of the sealing material,
wherein a connecting portion connecting a straight body of the sealing material and the liquid crystal injection port is folded on the outside of the liquid crystal display panel,
wherein the distance of the connecting portion of the sealing material increases toward the inside of the liquid crystal display panel,
wherein a sealant is provided to seal the liquid crystal injection port,
wherein the sealant enters the liquid crystal display panel, and
wherein the method includes the steps of:
forming the sealing material around the pair of substrates with the liquid crystal injection port formed in a portion thereof;
injecting the liquid crystal between the pair of substrates and the sealing material;
applying a UV curable resin to the liquid crystal injection port so that the UV curable resin enters the liquid crystal display panel; and
sealing the liquid crystal injection port by curing the UV curable resin by a light source capable of emitting light from an upper direction and/or lower direction with respect to the liquid crystal display panel.

6. The manufacturing method of the liquid crystal display device according to claim 5,
wherein an insulating film is formed on one of the pair of substrates,
wherein the insulating film is formed at a predetermined distance from an area where the liquid crystal injection port is formed,
wherein a step is formed between an end portion on the side of the liquid crystal injection port of the insulating film and the particular substrate on which the insulating film is formed, and
wherein in the process of sealing the liquid crystal injection port, the light is emitted from at least one side of the pair of substrates.

7. The manufacturing method of the liquid crystal display device according to claim 6,
wherein the light source is a fiber light source,
wherein in the process of sealing the liquid crystal injection port, the light is emitted from at least one side of the pair of substrates by means of the fiber light source.
